(19) United States
(12) Patent Application Publication
(10) Pub. No.: US 2010/0104707 A1
(43) Pub. Date: Apr. 29, 2010

(54) GRAIN POWDER COMPOSITION

(75) Inventor: Yoji KAMEO, Tokyo (JP)

Correspondence Address: OBLON, SPIVAK, MCCLELLAND MAIER & NEUSTADT, L.L.P., 1940 DUKE STREET, ALEXANDRIA, VA, 22314, US

(73) Assignee: KAO CORPORATION, Chuo-ku (JP)

(21) Appl. No.: 12/603,828

(22) Filed: Oct. 22, 2009

(30) Foreign Application Priority Data
Oct. 28, 2008 (JP) 2008-276312

(51) Int. Cl. A23L 1/0522; A21D 13/08

(52) U.S. Cl. 426/271; 426/622; 426/556

(57) ABSTRACT

The invention relates to a grain powder composition, obtainable by blending (A) 30 to 75 parts by weight of soft wheat flour, (B) 10 to 30 parts by weight of at least one or more members selected from moderate wheat flour, semi-hard wheat flour, and hard wheat flour or 0.5 to 4 parts by weight of wheat protein, and (C) 15 to 40 parts by weight of esterified starch or etherified starch, provided that the total of the 3 components is 100 parts by weight when (B) is not wheat protein.

### FIELD OF THE INVENTION

The present invention relates to a grain powder composition.

### BACKGROUND OF THE INVENTION

It is desirable for baked confectionery to have a light texture. There is also a demand for baked confectionery having an excellent dissolving feel in the mouth without a powdery feel in the mouth.

For the above demands, techniques which improves texture felt in the mouth by incorporating modified starch subjected to esterification, etherification or crosslinking treatment have been proposed. For example, in the production of baked confectionery, a method for producing baked confectionery characterized in that at least one starch modified product selected from an acetylated starch subjected to sodium hypochlorite treatment and having a substitution degree of 0.01 to 0.04 and a crosslinked starch having a swelling degree of 4 to 15 is used in an amount of 5 to 50 parts by weight based on 95 to 50 parts by weight of wheat flour has been disclosed (JP-A 10-99011). There is also disclosed a technique of compounding a processed sago starch as a secondary material (JP-A 2004-290068) and a technique of compounding an acetylated tapioca starch (JP-A 2006-166909) .

From the viewpoint of the health trend, physiological functions of modified starch have been noticed.

For example, an acetylated phosphoric acid crosslinked starch having a substitution degree of 0.06 and a hydroxypropylated phosphoric acid crosslinked starch having a substitution degree of 0.10 to 0.14 are exhibited to show digestion resistance to α-amylase and are suggested to show an effect of preventing a rapid increase in blood sugar after eating, induction of high blood sugar thereafter, and secretion in excess of insulin (Ebihara, Japanese Society of Nutrition and Food Science, Vol. 45 (6), p. 551 (1992)).

It is also disclosed that a hydroxypropylated starch, acetylated starch and octanylsuccinate starch are effective as an agent of preventing and ameliorating obesity and as an agent for preventing visceral fat accumulation (JP-A 2004-269458 and JP-A 2006-76918).

### SUMMARY OF THE INVENTION

The present invention relates to a grain powder composition, containing:

(A) 30 to 75 parts by weight of soft wheat flour,

(B) 10 to 30 parts by weight of at least one or more members selected from the group consisting of moderate wheat flour, semi-hard wheat flour, and hard wheat flour, and

(C) 15 to 40 parts by weight of esterified starch or etherified starch, provided that the total of the 3 components is 100 parts by weight.

The present invention relates also to a grain powder composition, containing:

(A) 30 to 75 parts by weight of soft wheat flour,

(B) 0.5 to 4 parts by weight of wheat protein, and

(C) 15 to 40 parts by weight of esterified starch or etherified starch.

Further, the present invention relates to baked confectionery containing the grain powder composition.

Further, the present invention provides a method for producing confectionery, containing the steps of mixing the above-mentioned grain powder composition.

### DETAILED DESCRIPTION OF THE INVENTION

In the above described background of the invention, when modified starch is used in baked confectionery, a reduction in the dissolving feel in the mouth, or deterioration in a powdery feel in the mouth, may be felt.

Particularly, it is disclosed in JP-A 10-99011 that when modified starch having a high degree of substitution is used, a dissolving feel in the mouth is reduced if acetylated starch having a substitution degree of 0.06 is used.

In view of these circumstances, the inventors have investigated improvement in the dissolving feel in the mouth or in a low powdery feel in the mouth when modified starch is used, and they found that in addition to the use of soft wheat flour, the above problem was solved by incorporating wheat flour having a protein content higher than in soft wheat flour.

According to the present invention, there is provided a baked confectionery with improvement in a dissolving feel in the mouth or in a low powdery feel in the mouth and suppression of deterioration over time. That is, the present invention provides a grain powder composition, from which baked confectionery is made, being improved in dissolving feel in the mouth and a less powdery feel in the mouth, even if a modified starch is used.

In the invention, the total of the 3 components, (A), (B) and (C), is 100 parts by weight when (B) is not wheat protein. When (B) is wheat protein, the amount of (B) is 0.5 to 4 parts by weight of wheat protein.

### <(A) Soft Wheat Flour>

Soft wheat flour is produced from soft wheat, and wheat such as western white wheat, white club wheat, etc. may be used as the raw material. The soft wheat flour used in the present invention is preferably wheat flour having a protein content of 6.5 to 9% by weight (hereinafter referred to simply as %), more preferably 6.8 to 8.0%.

The compounding amount of the component (A) in 100 parts by weight (referred to simply as parts) of the components (A), (B) and (C) in total, when (B) is not wheat protein, is 30 to 75 parts, preferably 40 to 70 parts. Within this range, excellent feeling of food, particularly feeling of the food in the mouth, can be obtained.

### <(B) Moderate Wheat Flour, Semi-Hard Wheat Flour, Hard Wheat Flour and Wheat Protein>

The present invention is characterized in that at least one or more members selected from (B) moderate wheat flour, semi-hard wheat flour, hard wheat flour and wheat protein is used in addition to the soft wheat flour (A).

The moderate wheat flour may be produced from intermediate wheat, and Australian standard white wheat, Canadian western red spring wheat, etc. may be used. The protein content thereof is around 9%, preferably in a range of 7.5 to 10.5%.

The semi-hard wheat flour and hard wheat flour are produced from hard wheat and semi-hard wheat, and the hard wheat flour includes Canada western red spring wheat and dark northern spring wheat, and the semi-hard wheat flour includes hard red winter wheat, etc. The protein content is preferably 11.5 to 12.5% in hard wheat flour or 10.5 to 12.5% in semi-hard wheat flour.

Wheat protein (gluten) is protein extracted from wheat flour. Wheat protein having a large high protein content is preferred. The content is preferably 60% or more, more preferably 70% or more.

A commercially available wheat protein may be used, for example, “A-glu series”, such as A-glu WP, A-glu G, A-glu K or Fine glu VP and the like, manufactured by Glyco Nutrition and Food Co., Ltd., may be preferably used.

Generally, soft wheat flour is used in baked confectionery. This is because when moderate wheat flour or hard wheat flour is used in baked confectionery, toasting generally makes it a hard to deteriorate feeling in the mouth when eating, and thus it makes it unsuitable for baked confectionery. However, when modified starch is used, moderate wheat flour, semi-hard wheat flour, hard wheat flour or wheat protein is used in combination with modified starch, and the hardness from toasting can be prevented and excellent dissolving feel in the mouth and less powdery feel in the mouth can be realized. From this viewpoint, semi-hard wheat flour, hard wheat flour or wheat protein is preferably used, and hard wheat flour is particularly preferably used as the component (B)

The compounding amount of the component (B) in the total amount of 100 parts of the components (A), (B) and (C), when (B) is not wheat protein, is 10 to 30 parts, preferably 15 to 25 parts, from the viewpoint of feeling during eating.

When component (B) is wheat protein, component (B) is 0.5 to 4 parts to 30 to 75 parts of component (A) and 15 to 40 parts of component (C). The amount of wheat protein is preferably 0.5 to 3 parts, more preferably 0.8 to 2 parts from the viewpoint of feeling during eating.

### <(C) Modified Starch>

In the present invention, esterified or etherified starch is used as modified starch.

The esterification includes acetylation, octenyl succination, and monoester phosphorylation, etc., and modified starch can be obtained by modification by reacting acetic anhydride, octencylsuccinic acid, phosphate or the like on starch. The phosphate includes sodium ortho-phosphate, sodium tripolyphosphate, etc. The etherification includes hydrohypropylation.

The degree of modification is expressed by the degree of substitution and generally defined by the number of substituents per glucose residue. A higher degree of substitution is indicative of a higher degree of modification, and in this case, the temperature of gelatinization of starch is decreased and the hydration of starch is swollen to provide a feeling of less powdery feel in the mouth. However, when the degree of substitution is too high, starch particles are easily disrupted during heating, and as a result, there is a problem of aging (hardening with time). As shown in the present invention, on the other hand, the component (B) is used in combination thereby solving such problem, thus realizing improvement in dissolving feel in the mouth as well as prevention in powdery feel in the mouth.

The effect of the present invention can be exhibited when any modified starch is used, but the effect can further be exhibited when the degree of substitution is high, that is, when the degree of substitution is higher than 0.04.

From the viewpoint of physiological functions, the degree of substitution in the case of esterified starch is preferably higher than 0.04, more preferably 0.05 to 0.1, even more preferably 0.06 to 0.09. Further, from the viewpoint of physiological functions, the degree of substitution in the case of etherified starch is preferably higher than 0.1, more preferably 0.1 to 0.5, and even more preferably 0.1 to 0.3.

The method of measuring the degree of substitution can be measured by a method described in a starch/related sugar experimental method, pp. 290 to 297 (edited by Nakamura and Kainuma and published by Gakkai Shuppan Center Co., Ltd., 1986).

The esterified or etherified starch is preferably one further subjected to a crosslinked treatment.

The crosslinked treatment includes phosphoric acid crosslinking and adipic acid crosslinking. From the viewpoint of production from starch with relatively low costs and high purity in an easy process, acetylated adipic acid crosslinked starch, acetylated phosphate acid crosslinked starch, hydroxypropylated phosphoric acid crosslinked starch, and monoester phosphoric acid crosslinked starch are preferable.

The degree of crosslinking is expressed by the degree of swelling. A high degree of crosslinking is indicative of a lower degree of swelling, and the feeling in the mouth when eating is hard, and powdery feel easily occurs. On the other hand, when the degree of crosslinking is low, that is, when the degree of swelling is too high, starch particles are easily broken and aging is easily caused. However, if a crosslinked starch having a high degree of swelling is used together with the component (B), aging can be suppressed, and baked confectionery stored for a long time can be still provide a pleasant feeling when eating.

From these viewpoints, the degree of swelling is preferably 8 or more, more preferably 15 or more. The degree of swelling is preferably 29 or less, more preferably 25 or less.

The degree of swelling is expressed as follows: A sample of 1.0 g in terms of dry weight is dispersed in 100 mL purified water, then heated at 90° C. for 30 minutes and cooled to 30° C., and the resulting gelatinized liquid is centrifuged (3000 rpm, 10 minutes) and thereby separated into a gel layer and a supernatant layer, and the weight of the gel layer is measured as A, and the gel layer measured for its weight is dried into the solid (105° C., a constant weight) to determine the weight B, and A/B is expressed as the degree of swelling.

The raw material of modified starch includes, for example, waxy corn starch, corn starch, wheat starch, rice starch, glutinous rice starch, potato starch, sweet potato starch, and tapioca starch.

The amount of the component (C), based on 100 parts of the components (A), (B) and (C) in total, is 15 to 40 parts, more preferably 20 to 35 parts. Within this range, excellent feeling while eating, particularly a dissolving feel in the mouth can be obtained.

The amount of proteins, based on 1000 of the components (A), (B) and (C) in total, is preferably 5.2 to 6.8%, more preferably 5.5 to 6.5%. Within this range, particularly a dissolving feel in the mouth is made excellent.

The grain powder composition can contain saccharides, oils and fats, swelling agents, common salt, flavors, emulsifying agents, etc. as arbitrary agents in addition to the components (A), (B) and (C). The saccharides referred to herein may be sugars, glucose, starch syrup, maltose, sorbitol, etc. for the purpose of providing sweetness, color and moisture.

The content of these arbitrary components in the grain powder composition is preferably 60% or less, more preferably 35% or less.

### <Baked Confectionery>

The baked confectionery of the present invention include cookies, biscuits, shortbreads, crackers, hardtacks, pretzels, pies, cut breads, and processed products thereof. From the viewpoint of important textures such as dissolution in the mouth and less powdery feel in the mouth, cookies, biscuits, shortbreads or crackers are preferable.

In recent years, it is desirable for biscuits, cookies and shortbreads to provide a softer feeling in the mouth when eating, wherein the content of water in the resulting baked confectionery is 5 to 15%, preferably 6 to 12%, and from the viewpoint of storage ability, the water activity of baked confectionery is preferably 0.4 to 0.8, more preferably 0.5 to 0.7.

The raw materials of the baked confectionery in the present invention includes not only the grain powder composition as a main material, but also subsidiary materials such as fats and oils, saccharides, eggs, water, dairy products, common salt, yeasts, seasonings (sodium glutamate and nucleic acids), a preservative, reinforcing agents such as vitamins, calcium, etc., proteins, amino acids, chemical expanding agents, flavors, and sweetener, as necessary. Further, dried fruits such as raisin etc., wheat flour bran, whole grain powder and chocolate can be suitably used.

The fats and oils used in the present invention may be those of animal or vegetable origin having plasticity, such as butter, lard, margarine, shortening, etc., or liquid oil, or various hydrogenated hardened oils thereof (solid fats) and transesterified oils thereof. The amount of the fats and oils compounded is 5 to 72 parts, preferably 10 to 60 parts, even more preferably 20 to 55 parts, based on 100 parts of the components (A), (B) and (C) in total.

The saccharides used in the present invention may be all saccharides used in usual baked confectionery. Specific examples include monosaccharides such as glucose, fructose and galactose, polysaccharides such as maltose, sucrose, maltose, starch syrup, isomerized sugar, invert sugar, cyclodextrin, branched cyclodextrin and dextrin, and reduced sugars such as starch reduced dehydrates, and these can be used alone or as a mixture of two or more thereof. The compounding amount thereof is 5 to 90 parts, more preferably 10 to 70 parts, and even more preferably 15 to 55 parts, based on 100 parts of the components (A), (B) and (C) in total.

As the sweetener, sugar alcohols such as sorbitol, maltitol and xylitol, and sclarose, aspartame and potassium acesulfame can be used.

In the aspect of the present invention, the method for producing baked confectionery includes a rotary, cutting embossing, wire cutting, root presto and deposit.

### EXAMPLES

The present invention is described more in details by reference to Examples. The Examples are provided for illustrative purposes only and not intended to limit the present invention.

### [Modified Starch]

The degree of substitution and degrees of swelling of the acetyl group and hydroxypropyl group of modified starch used in Examples are shown in Table 1.

The method of measuring the degree of substitution was measured according to the method described in the document described above. The method of measuring the degree of swelling is used in the method described above.

TABLE 1

| | | | Degree of | Degree of |
|---|---|---|---|---|
| kind of starch | Trade name | Manufacture | substitution | swelling |
| Aetylated adipic acid | Colfro 67 | National Starch Co., Ltd. | 0.08 | 22 |
| crosslinked starch | | | | |
| Hydroxypropylated | Thermufro | National Starch Co., Ltd. | 0.15 | 18 |
| phosphoric acid | | | | |
| crosslinked starch | | | | |
| Aetylated phosphoric | Mapusu #449 | Nihon Shokuhin Kako | 0.06 | 19 |
| acid crosslinked starch | | Co., Ltd. | | |
| Acetylated starch | Matsutani Sakura | Matsutani Chemical | 0.02 | — |
| | | Industry, Co., Ltd. | | |
| Phosphoric acid | Pine Bake CC | Matsutani Chemical | — | 6 |
| crosslinked starch | | Industry, Co., Ltd. | | |

The above modified starch, hard wheat flour (Camellia, a protein content of 11.8%, manufactured by Nisshin Flour Milling Co., Ltd.) and soft wheat flour (Violet, a protein content of 7.1%, manufactured by Nisshin Flour Milling Co., Ltd.) were mixed in compositions in Table 2 to produce grain powder compositions (grain powder 1 to 17) .

### [Method of Producing Shortbread]

1) Material a (margarine, edible processed oils and fats, white superior soft sugar, oligosaccharides, powdered skimmed milk, condensed soybean proteins, cheese powder, dried albumen, common salt) was weighed, placed in a mixer, and stirred at low speed for 30 seconds and at moderate speed for 3 minutes, to prepare a dough.
2) While the above 1) was stirred at low speed for 30 seconds, beaten eggs were divided into three parts and added. The first egg water was added and then stirred at low speed for 30 seconds, and when the second egg water was added, common salt was added while egg water was dissolved, followed by stirring at low speed for 30 seconds.

After the above was finished, oil adhered to a wall of a mixer was scraped away, and the final egg water was added and stirred at low speed for 30 seconds, followed by stirring at moderate speed to form an uniform cream (stirring time for 1 minute at moderate speed).

3) Material c was introduced into the above 2) and stirred at low speed for 45 seconds.
4) 20 g of the above 3) was weighed and stuffed into rectangular baking pans having 72 mm in length×22 mm in width×14 mm in height and arranged them on a baking sheet with a release paper, and 6 holes were opened with a toothpick on the surface of dough stuffed into the baking pans. 4 pieces×3 rows (12 in total) were arranged on each baking sheet.
5) Further, 3 baking sheets were further arranged below the baking sheets, and an aluminum foil was placed on the surface.
6) Baking was conducted in an oven at 160° C. After baking with an aluminum foil for 20 minutes, the aluminum was removed, and baking was performed for 20 minutes.
7) After cooling at room temperature for 20 minutes on a net after baking, the products were placed in a polyethylene bag provided with a zipper and were left for 1 day and 1 week respectively in a temperature-controlled chamber at 20° C. to provide shortbread samples.

The material composition is shown below.

| Material a: | | |
|---|---|---|
| Margarine | 48 | parts |
| Edible processed oils and fats | 3 | parts |
| White superior soft sugar | 25 | parts |
| Oligosaccharides | 5 | parts |
| Powdered skimmed milk | 5 | parts |
| Condensed soybean proteins | 5 | parts |
| Cheese powder | 8 | parts |
| Dried albumen | 2 | parts |
| Common salt | 1 | part |
| Material b: | | |
| Whole egg | 29 | parts |
| Material c: | | |
| Grain powder composition | 100 | parts |

In evaluation of the Examples and Comparative Examples, shortbread samples were evaluated sensorily (after 1 day and 7 days in less powdery feel in the mouth and in dissolving feel in the mouth).

### [Sensory Evaluation]

5: Very excellent in level compared with the control example.
4: Excellent in level compared with the control example.
3: Equal in level compared with the control example.
2: Inferior in level compared with the control example.
1: Very inferior in level compared with the control example.

The results are shown in Table 3. The samples after 7 days were evaluated relatively to the control example after 1 day, marked as 3

TABLE 2

| | Grain | Grain | Grain | Grain | Grain | Grain | Grain | Grain | Grain |
|---|---|---|---|---|---|---|---|---|---|
| Grain powder | powder | powder | powder | powder | powder | powder | powder | powder | powder |
| composition | 1 | 2 | 3 | 4 | 5 | 6 | 7 | 8 | 9 |
| Soft wheat flour | 50 | 50 | 50 | 50 | 70 | 70 | 70 | 60 | 40 |
| Hard wheat flour | 20 | 20 | 20 | 20 | — | — | — | 20 | 20 |
| Acetylated adipic acid | 30 | — | — | — | 30 | — | — | 20 | 40 |
| crosslinked starch | | | | | | | | | |
| Hydroxypropylated | — | 30 | — | — | — | 30 | — | — | — |
| phosphoric acid | | | | | | | | | |
| crosslinked starch | | | | | | | | | |
| Acetylated phosphoric | — | — | 30 | — | — | — | 30 | — | — |
| acid crosslinked starch | | | | | | | | | |
| Acetylation starch | — | — | — | 30 | — | — | — | — | — |
| Phosphoric acid | — | — | — | — | — | — | — | — | — |
| crosslinked starch | | | | | | | | | |
| Wheat protein (A-glu | | | | | | | | | |
| WP) | | | | | | | | | |
| Protein content ratio | 5.9 | 5.9 | 5.9 | 5.9 | 5.0 | 5.0 | 5.0 | 6.6 | 5.2 |
| (% by weight) | | | | | | | | | |
| Total | 100 | 100 | 100 | 100 | 100 | 100 | 100 | 100 | 100 |

| | Grain | Grain | Grain | Grain | Grain | Grain | Grain | Grain |
|---|---|---|---|---|---|---|---|---|
| Grain powder | powder | powder | powder | powder | powder | powder | powder | powder |
| composition | 10 | 11 | 12 | 13 | 14 | 15 | 16 | 17 |
| Soft wheat flour | 60 | 40 | 30 | 30 | 67 | 80 | 50 | 69 |
| Hard wheat flour | 10 | 30 | 20 | 40 | 3 | 20 | 20 | 0 |
| Acetylated adipic acid | 30 | 30 | 50 | 30 | 30 | — | — | — |
| crosslinked starch | | | | | | | | |
| Hydroxypropylated | — | — | — | — | — | — | — | — |
| phosphoric acid | | | | | | | | |
| crosslinked starch | | | | | | | | |
| Acetylated phosphoric | — | — | — | — | — | — | — | — |
| acid crosslinked starch | | | | | | | | |
| Acetylation starch | — | — | — | — | — | — | — | — |
| Phosphoric acid | — | — | — | — | — | — | 30 | 30 |
| crosslinked starch | | | | | | | | |
| Wheat protein (A-glu | | | | | | | | 1 |
| WP) | | | | | | | | |
| Protein content ratio | 5.4 | 6.4 | 4.5 | 6.9 | 5.1 | 8.0 | 5.9 | 5.8 |
| (% by weight) | | | | | | | | |
| Total | 100 | 100 | 100 | 100 | 100 | 100 | 100 | 100 |

TABLE 3

| Eating feel sensory | | | | | Comparative | Comparative | Comparative | | |
|---|---|---|---|---|---|---|---|---|---|
| evaluation | Example 1 | Example 2 | Example 3 | Example 4 | example 1 | example 2 | example 3 | Example 5 | Example 6 |
| Grain powder | Grain | Grain | Grain | Grain | Grain | Grain | Grain | Grain | Grain |
| composition | powder 1 | powder 2 | powder 3 | powder 4 | powder 5 | powder 6 | powder 7 | powder 8 | powder 9 |
| (After one day) | | | | | | | | | |
| Less powdery | 5 | 4 | 4 | 3 | 2 | 2 | 2 | 4 | 4 |
| dissolving feel in | 5 | 4 | 4 | 2 | 2 | 2 | 2 | 4 | 5 |
| the mouth | | | | | | | | | |
| (After 7 days) | | | | | | | | | |
| Less powdery | 4 | 4 | 4 | 3 | 1 | 1 | 2 | 4 | 3 |
| dissolving feel in the | 4 | 3 | 3 | 2 | 1 | 1 | 1 | 3 | 4 |

| Eating feel sensory | | | Comparative | Comparative | Comparative | Comparative | Comparative | | Control |
|---|---|---|---|---|---|---|---|---|---|
| evaluation | Example 7 | Example 8 | example 4 | example 5 | example 6 | example 7 | example 8 | Example 9 | example |
| Grain powder | Grain | Grain | Grain | Grain | Grain | Grain | Grain | Grain | Soft |
| composition | powder 10 | powder 11 | powder 12 | powder 13 | powder 14 | powder 15 | powder 16 | powder 17 | wheat flour |
| (After one day) | | | | | | | | | |
| Less powdery | 4 | 4 | 3 | 3 | 3 | 3 | 2 | 3 | 3 |
| dissolving feel in | 4 | 4 | 2 | 2 | 3 | 2 | 2 | 4 | 3 |
| the mouth | | | | | | | | | |
| (After 7 days) | | | | | | | | | |
| Less powdery | 4 | 3 | 2 | 2 | 2 | 1 | 1 | 3 | 2 |
| dissolving feel in | 4 | 4 | 1 | 1 | 1 | 1 | 1 | 3 | 2 |
| the mouth | | | | | | | | | |

Baked confectionery, produced by using a specific modified starch and hard wheat flour in the range of the invention as described above, is found to improve less powdery feel in the mouth and of dissolution in the mouth, even if modified starch has a sufficient substitution degree or compounding amount to exhibit physiological functions.

1. A grain powder composition, comprising:
(A) 30 to 75 parts by weight of soft wheat flour,
(B) 10 to 30 parts by weight of at least one or more members selected from the group consisting of moderate wheat flour, semi-hard wheat flour, and hard wheat flour, and
(C) 15 to 40 parts by weight of esterified starch or etherified starch, provided that the total of the 3 components is 100 parts by weight.

2. The grain powder composition according to claim 1, wherein the component (B) is hard wheat flour.

3. The grain powder composition according to claim 1 or 2, wherein the content of proteins in the grain powder composition is 5.2 to 6.8% by weight.

4. The grain powder composition according to claim 1 or 2, wherein the degree of substitution of esterified starch or etherified starch is higher than 0.04.

5. The grain powder composition according to claim 1, wherein the esterified starch or etherified starch is crosslinked starch.

6. The grain powder composition according to claim 5, wherein the degree of swelling of crosslinked starch is higher than 15.

7. The grain powder composition according to claim 5 or 6, wherein the crosslinked starch is acetylated crosslinked starch or hydroxypropylated crosslinked starch.

8. A baked confectionery, comprising the grain powder composition of claim 1 or 2.

9. The baked confectionery according to claim 8, wherein the baked confectionery is selected from the group consisting of cookies, biscuits, shortbreads and crackers.

10. The baked confectionery according to claim 8 or 9, wherein the water content is 5 to 15% by weight.

11. A method for producing confectionery, comprising the steps of mixing the grain powder composition of claim 1 or 2.

12. A grain powder composition, comprising:
(A) 30 to 75 parts by weight of soft wheat flour,
(B) 0.5 to 4 parts by weight of wheat protein, and
(C) 15 to 40 parts by weight of esterified starch or etherified starch.
